(19) United States
(12) Patent Application Publication
(10) Pub. No.: US 2024/0370382 A1
(43) Pub. Date: Nov. 7, 2024

(54) SYSTEM-ON-CHIP HAVING A MEMORY CONTROLLER AND CORRESPONDING MEMORY CONTROL METHOD

(71) Applicant: STMicroelectronics International N.V., Geneva (CH)

(72) Inventors: Loic Pallardy, Rouillon (FR); Vincent Berthelot, Saint Pavace (FR)

(21) Appl. No.: 18/652,555

(22) Filed: May 1, 2024

(30) Foreign Application Priority Data
May 2, 2023 (FR) 2304400

(51) Int. Cl. G06F 12/14

(52) U.S. Cl. CPC G06F 12/1491; G06F 12/1483

(57) ABSTRACT

The system on chip includes a memory controller adapted to receive transactions containing transaction information defining an access to a memory, the memory controller being configured to store the transaction information in a command register, and to control the access to the memory from the content of the command register. The memory controller includes verification circuitry configured to determine the access to the memory depending on a comparison between the transaction information stored in the command register and a list of special information defining special transactions.

### CROSS-REFERENCE TO RELATED APPLICATIONS

This application claims the benefit of French Patent Application No. 2304400, filed on May 2, 2023, which application is hereby incorporated herein by reference.

### TECHNICAL FIELD

Embodiments and implementations relate to integrated circuits, and in particular to Systems on Chip (SoC) including a memory controller.

### BACKGROUND

In order to contribute to guaranteeing the security of systems on chip, techniques for isolating resources make it possible to authorize or restrict the access to the resources of the system, and for example particular memory regions. “Illegal” access is referred to when a transaction does not comply with the access restrictions established by the respective access rights. Techniques for isolating resources in this context are usually called “firewalls”.

In conventional techniques for isolating resources, firewalls may be provided on the memory controller to provide protection during execution depending on the execution context, for example identified by a compartmentalization identifier “CID”, a security level, and/or by a privilege level.

For example, a first type of firewall may be adapted to the slave device protection RISUP, in order to filter which context may access the controller in order to send commands to the external memory to read, write or erase data. This first type of firewall RISUP does not verify the commands sent to the memory, but only which context accesses the controller at the time of the execution.

A second type of firewall may be adapted to the slave address protection RISAF, in order to filter which regions of the memory may be accessed by which contexts at the time of the execution.

However, these firewalls are not conventionally able to limit the accesses to the external memory depending on a security level of the system on chip specific to the boot process, and which changes as the boot process progresses.

Indeed, during the process for booting the system on chip, the security level of the system on chip has fewer and fewer access permissions, in such a way as to “lock” the secrets, that is to say make them inaccessible, when they have been used.

Yet, as conventional firewalls do not make it possible to filter depending on the security level of the system on chip, it is possible that a command coming from an authorized context, acts on a memory region that should be protected during the boot process.

Thus, there is a need to reinforce the mechanisms for protecting the system on chip external memories, particularly in the context of the boot process and in relation to the security of the system on chip.

### SUMMARY

In accordance with an aspect, a system on chip includes a memory controller adapted to receive transactions containing transaction information defining an access to a memory, for example an external memory, the memory controller being configured to store the transaction information in a command register, and to control the access to the memory from the content of said command register, wherein the memory controller includes verification circuitry configured to determine the access to the memory depending on a comparison between the transaction information stored in the command register and a list of special information defining special transactions, for example prohibited transactions or authorized transactions.

Thus, it is the memory controller itself that implements an additional protection mechanism in relation to special transactions (i.e., the list of special information), in addition to possible firewalls. This additional protection may thus make it possible to complete a gap in the protection established by the firewalls, particularly in the context of the boot process.

In an embodiment, the verification circuitry is configured to receive a security level of the system on chip, and to perform said determination of the access to the memory depending on the security level of the system on chip.

This makes it possible to ensure the security of the system on chip depending on the security level of the system, in particular in such a way as to take into account its changes during the process for booting the system.

It is understood that the security level corresponds to a scalable security level that is automatically modified as the boot process progresses so as to have increasingly restricted accesses. For example, the safety level changes temporarily so as to block the accesses to the memory regions containing information for the boot process, as soon as this information has been used in the boot process.

Moreover, it will be noted that the scalable security level that modifies automatically during the boot process does not correspond to the “secure” or “non-secure” contexts, or to the “privileged” or “non-privileged” contexts, which are conventionally filtered by the firewalls RISUP, RISAF. Indeed, said contexts are typically attributed for each device (master, resource, peripheral, etc.), possibly in a controlled way by a mechanism for managing access rights. In any case, the secure/privileged contexts are not conventionally adapted to be modified automatically as the boot process progresses.

In an embodiment, the list of special information defining special transactions is created respectively for each possible security level of the system on chip.

In an embodiment, the verification circuitry is configured to perform said determination so that the access is blocked if at least one of said items of transaction information stored in the command register belongs to said list of special information; or if at least one of said items of transaction information stored in the command register does not belong to said list of special information.

In an embodiment, the list of special information is established on at least one of the following transaction information types: a pre-established command for an action in the memory; a memory region address; a memory region size.

In accordance with another aspect, a method for controlling a memory, implemented by a memory controller of a system on chip, comprises receiving the transactions containing transaction information defining a respective access to the memory, storing the transaction information received in a command register, the access to the memory being controlled from the content of said command register, the method further comprising determining the access to the memory depending on a comparison between the transaction information stored in the command register and a list of special information defining special transactions, for example prohibited transactions or authorized transactions.

According to one implementation, the method comprises receiving a security level of the system on chip, and wherein said determination of the access to the memory is performed depending on the security level of the system on chip.

According to one implementation, the list of special information defining special transactions is created respectively for each possible security level of the system on chip.

According to one implementation, said determination is performed so that the access is blocked if at least one of said items of transaction information stored in the command register belongs to said list of special information, or if at least one item of said transaction information stored in the command register does not belong to said list of special information.

According to one implementation, the list of special information is established on at least one of the following transaction information types: a pre-established command for an action in the memory; a memory region address; a memory region size.

### BRIEF DESCRIPTION OF THE DRAWINGS

Other advantages and features of the invention will become apparent upon examination of the detailed description of embodiments and implementations, without limitation, and of the appended drawings, wherein:

FIG. 1 illustrates an embodiment of a system on chip;

FIG. 2 illustrates another embodiment of a system on chip; and

FIG. 3 illustrates an example of a process for booting a system on chip.

### DETAILED DESCRIPTION OF ILLUSTRATIVE EMBODIMENTS

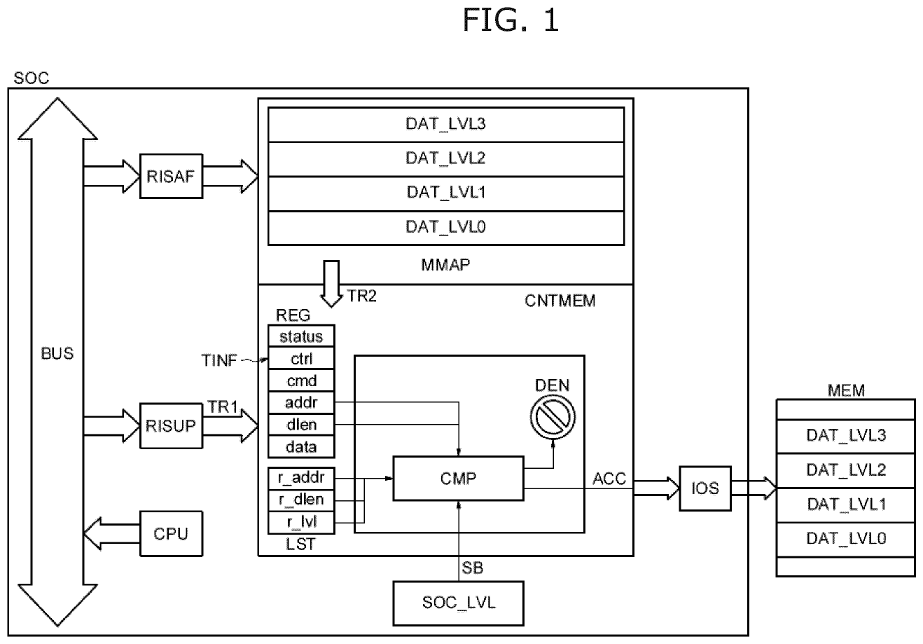

FIG. 1 schematically illustrates an embodiment of a system on chip SOC, such as for example a microcontroller or a microprocessor, including a master device CPU, and a memory controller CNTMEM intended to control accesses to a memory MEM, for example a “Flash” or “EEPROM” non-volatile external memory.

The memory MEM is for example connected to the memory controller CNTMEM of the system on chip SOC, via an input-output interface IOS.

For example, the master device CPU may be a processor or a Central Processing Unit, adapted to implement software functions; or a master device of the Direct Memory Access (DMA) type.

The master device CPU is for example at the origin of the accesses to the memory MEM, by transactions TR1, TR2 communicated on an interconnection bus BUS to the memory controller CNTMEM.

For example, the interconnection bus BUS may be a bus of the “AXI” (Advanced extensible Interface) type, or of the “AHB” (Advanced High-performance Bus) type, which are of the “AMBA” (Advanced Microcontroller Bus Architecture) microcontroller bus types.

Each transaction TR1, TR2 contains transaction information TINF defining a respective access to the memory MEM. The transaction information TINF may for example contain information of the cmd access type in read, in write or possibly in erase; an identification of the memory region MEM with a start address addr and size dlen; write data; and other transaction information “status”, “ctrl”.

Moreover, in order to access the memory MEM, a first type of transaction TR1 is based on a command communicated to the controller CNTMEM; and a second type of transaction TR2 is based on an address or a region of the memory, for example depending on a partition (or “mapping”) of the memory MMAP (usually referred to as “memory map”).

For example, a first firewall RISUP may be provided to authorize or restrict the accesses to the controller CNTMEM by transactions of the first type TR1, such as depending on the access rights to the memory of the master device CPU in relation to an execution context; and a second firewall RISAF may be provided to authorize or restrict the accesses to the controller CNTMEM by transactions of the second type TR2, such as depending on access rights to respectively each memory region MMAP by the master device CPU.

As such, the two types of transactions TR1, TR2 contain the transaction information TINF that enables the access.

In addition, in both cases, the memory controller CNTMEM is configured to store the transaction information TINF in a command register REG, and to control the access to the memory MEM from the content of said command register REG.

Furthermore, the memory controller CNTMEM includes, internally, verification circuitry CMP configured to determine the effective access ACC to the memory MEM, depending on a comparison between the transaction information stored in the command register REG and a list of special information LST.

Each item of special information of the list LST identifies for example a prohibited transaction, or an access ACC prohibited to the memory MEM.

For example, the verification circuitry CMP is configured in this regard to block the access DEN if at least one item of said transaction information stored in the command register REG belongs to said list of prohibited information LST.

Alternatively, each item of special information of the list LST identifies for example an authorized transaction, or an authorized access ACC to the memory MEM.

For example, the verification circuitry CMP is configured in this regard to block the access DEN if at least one item of the transaction information stored in the command register REG does not belong to the list of authorized information LST.

According to the choice of design (particularly the completeness) of the list of special information, the verification circuitry CMP may be configured to block the access DEN if none of the transaction information stored in the command register REG belong to the list of authorized information LST.

Advantageously, the verification circuitry CMP is configured to perform the determination of the access to the memory depending on the security level of the system on chip SOC_LVL; and for example the list of special information LST may be created respectively for each possible security level SOC_LVL of the system on chip SOC.

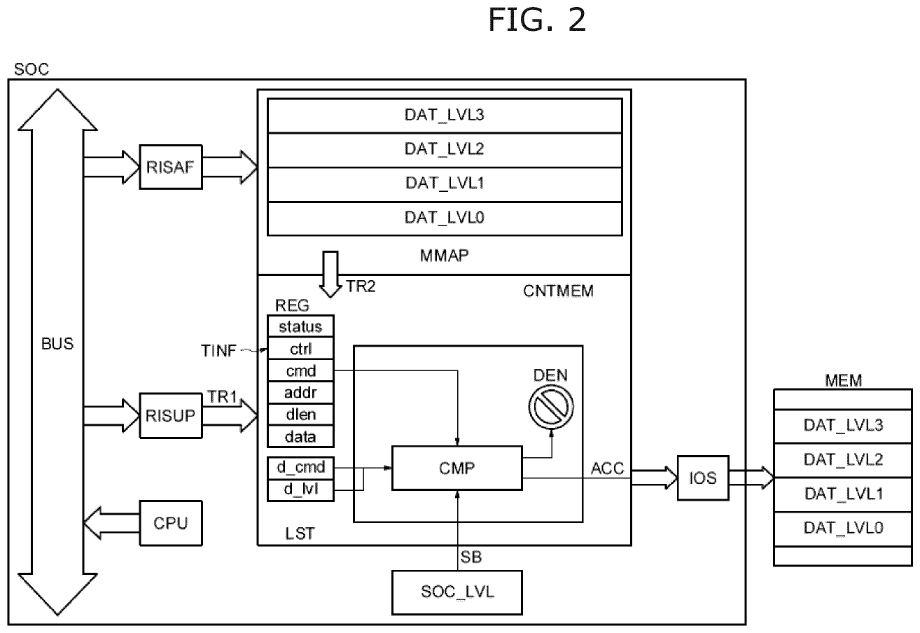

In this regard, each element of the list LST is for example related to an identification of the security level r_lvl, d_lvl (see below, FIG. 2).

The security level of the system on chip SOC_LVL is for example communicated by an internal bus dedicated in a hardware and centralized manner for the system on chip SOC. In particular, it will be noted that the security level SOC_LVL is not modifiable by software programming.

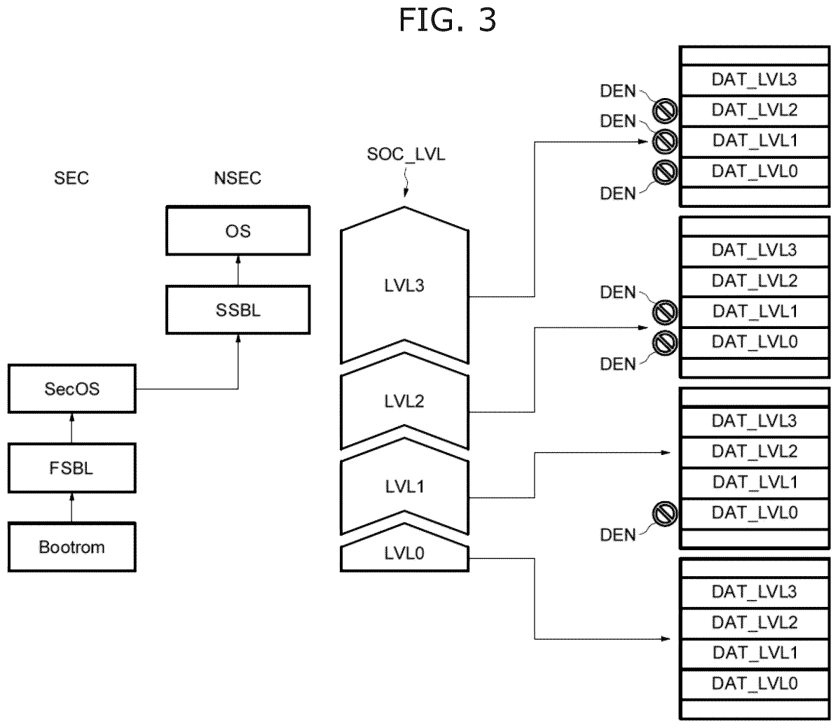

The security level SOC_LVL (or LVL0-LVL3; see below, FIG. 3) corresponds for example in practice to a scalable security level that is automatically modified as the boot process progresses, so as to have increasingly restricted accesses. For example, the safety level changes temporarily so as to block the accesses to the memory regions containing information for the boot process, as soon as this information has been used in the boot process.

Moreover, it will be noted that the scalable security level SOC_LVL does not correspond to the “secure” or “non-secure” contexts, or to the “privileged” or “non-privileged” contexts, which are conventionally filtered by the firewalls RISUP, RISAF. Indeed, the secure/privileged contexts are typically attributed for each device (master, resource, peripheral, etc.), possibly in a controlled way by a software mechanism for managing access rights.

The list of special information LST is established on at least one of the following transaction information types: a pre-established command for an action in the memory cmd; a memory region address addr; a memory region size dlen.

In a first example, illustrated by FIG. 1, each element of the list of special information LST includes a memory region start address r_addr and a memory region size r_dlen.

Thus, in this first example, the additional verification circuitry CMP have been integrated directly internally into the memory controller CNTMEM. The verification circuitry CMP offers an additional protection of the firewall type, on a number N of regions (depending on the product) of the memory MEM.

Each region is thus defined by an address r_addr and a length r_dlen, according to the external memory, the protocol used (for example this may concern a raw address, a page address or a block address); as well as by the lowest authorized security level r_lvl, or the first unauthorized level r_lvl depending on the desired logic.

The configuration of the regions in the list LST may be locked so as to never be reconfigured or overloaded by another software component.

Regardless of the transaction type TR1, TR2 (by transmission of a command or by an access via a segmentation/mapping) the address of the transaction addr, loaded in the command register REG is compared with the addresses r_addr contained in the list LST. If the address addr belongs to a region of the list LST, the current security level of the system on chip SOC_LVL is compared with the security level r_lvl that corresponds to the identified address “r_addrcaddr”. If the current security level SOC_LVL is higher than that of the identified region r_lvl, the transaction is authorized ACC, otherwise it is blocked, or denied, DEN and the memory controller CNTMEM may send back an error.

The same verification process may be carried out for the last address of the transaction, equal to the start address added with the length of the data addr+dlen. If the last address of the transaction is outside of all of the regions of the list LST, then the transaction is authorized ACC.

FIG. 2 illustrates a second example, wherein each element of the list of special information LST includes a pre-established command for an action in the memory d_cmd.

In the second example, the additional verification circuitry CMP is also integrated directly internally into the memory controller CNTMEM, in order to offer an additional protection of the firewall or “black list” (list of prohibited commands), or “white list” (list of authorized commands) type, on a number M of commands (depending on the product).

The pre-established commands d_cmd may for example be coded on 8 bits, according to the external memory or the protocol used. For example, this may concern commands for erasing sectors of the memory, or even the entire memory. The region to be protected may be different from the sector of the memory impacted by the command, given that these commands may be sent with an address addr that does not correspond to the region to be protected DAT_LVL0-DAT_LVL3 (in the case of FIG. 1), while having an impact on the region to be protected, for example DAT_LVL0, typically when the region to be protected is located inside the sector.

Each command of the list d_cmd is related to the lowest authorized security level r_lvl, or the first unauthorized level r_lvl depending on the desired logic.

The configuration of the commands in the list LST may be locked so as to never be reconfigured after the initialization to ensure that no one will modify it during the execution.

Regardless of the transaction type TR1, TR2 (by command or by identification of a segmentation/mapping) the transaction information that identifies a command cmd, that is to say an action in memory, located in the command register REG, is compared to the special commands d_cmd contained in the list LST.

If the transaction information that identifies the command cmd belongs to the list LST, the current security level of the system on chip SOC_LVL is compared with the security level d_lvl that corresponds to the identified command “cmd=d_cmd”.

In an alternative where the list of special commands LST contains prohibited commands d_cmd, if the current security level SOC_LVL is lower (that is to say having more restricted accesses) than that of the identified command d_lvl, then the transaction is blocked or denied DEN, and the memory controller CNTMEM may send back an error.

In the opposite case, if the current security level SOC_LVL is higher (that is to say has more permissions) than that of the identified command d_lvl, or if the transaction information that identifies the command cmd does not belong to the list of prohibited commands LST, then the command cmd is authorized and the transaction is executed normally, that is to say that the memory controller CNTMEM controls the access ACC to the memory MEM.

In another alternative where the list of special commands LST contains authorized commands d_cmd, if the current security level SOC_LVL is higher than or equal to (that is to say has the same or higher permission) that of the identified command d_lvl, then the command cmd is authorized and the transaction is executed normally, or in other words the memory controller CNTMEM controls the access ACC to the memory MEM.

In the opposite case, if the current security level SOC_LVL is lower (that is to say having more restricted accesses) than that of the identified command d_lvl, or if the transaction information that identifies the command cmd does not belong to the list of authorized commands LST, is blocked or denied DEN, and the memory controller CNTMEM may send back an error.

The list of special commands LST may be a simple set of registers. The number “M” of registers depends on the needs of the product.

FIG. 3 illustrates an example of a process for booting the system on chip SOC, such as described above in relation to FIGS. 1 and 2, during which a security level of the system on chip LVL0-LVL3 changes as the boot process progresses.

In particular, it should be understood that the security level LVL0-LVL3 (or SOC_LVL-FIGS. 1 and 2) changes temporarily so as to have increasingly restricted accesses, particularly so as to block the accesses to the memory regions containing information for the boot process, as soon as this information has been used in the boot process.

It will be noted that in this example, the digital values representative of the security levels LVL0-LVL3 are incremented as the security level lowers, or in other words as the context has fewer and fewer access permissions.

Thus for example, during a step of initializing the Bootrom boot, the initial boot code is loaded from a fixed location of the external memory MEM immediately available for the processor when the execution begins, for example the location DAT_LVL0.

In the context of this very first Bootrom step, the security level LVL0 has the most possible access permissions, and all of the memory regions DAT_LVL0-DAT_LVL3 (and therefore all of the possible secrets that they contain) are accessible.

Subsequently, for example, a first stage bootloader FSBL step is implemented.

In the context of this first stage bootloader FSBL, the security level LVL1 corresponds to a secure boot level, wherein the secrets of the step of initializing the Bootrom boot are no longer used, and are therefore hidden. To this end, the access to the memory region DAT_LVL0 corresponding to the Bootrom context is blocked DEN. The other memory regions DAT_LVL1-DAT_LVL3 are accessible.

Subsequently, for example, a step SecOS of executing a secure operating system is implemented.

In the context of the secure operating system SecOS, the security level LVL2 corresponds to a secure level, wherein the secrets of the first stage bootloader FSBL, such as specific keys, are no longer used, and are therefore hidden. To this end, the access to the memory region DAT_LVL1 corresponding to the FSBL context is blocked DEN. The access to the memory region DAT_LVL0 of the Bootrom context is still blocked DEN. The other memory regions DAT_LVL2-DAT_LVL3 are accessible.

Subsequently, for example, steps SSBL, OS corresponding to a non-secure NSEC context are implemented.

In the non-secure NSEC context, the security level LVL3 corresponds to a non-secure level, wherein only the “secrets” that can be used by the non-secure operating system OS are accessible. To this end, the access to the memory region DAT_LVL2 corresponding to the SecOS context is blocked DEN. The access to the memory regions DAT_LVL0-DAT_LVL1 of the preceding FSBL, Bootrom contexts are still blocked DEN. The memory region DAT_LVL3 is accessible.

It should be understood that the boot process described above corresponds to a simplified example, for illustrative purposes.

In summary, embodiments and implementations are described above of a mechanism inside the memory controller CNTMEM, for implementing additional protections for sensitive memory regions DAT_LVL0-DAT_LVL3, by way of the list of prohibited or authorized transactions LST, additionally with possible conventional firewalls RISUP-RISAF of the system on chip SOC. This additional protection CMP may thus make it possible to complete a gap in the protection, particularly in the context of the boot process, and furthermore in a way adaptable to all product types.

What is claimed is:

1. A system on chip comprising:
a memory controller, the memory controller configured to receive transactions containing transaction information for an access to a memory, store the transaction information in a command register, and control the access to the memory from the content of the command register, the memory controller comprising verification circuitry configured to determine the access to the memory depending on a comparison between the transaction information stored in the command register and a list of special information comprising special transactions.

2. The system on chip according to claim 1, wherein the verification circuitry is configured to receive a security level of the system on chip and to perform the determination of the access to the memory depending on the security level of the system on chip.

3. The system on chip according to claim 2, wherein the list of special information comprising special transactions is created respectively for each possible security level of the system on chip.

4. The system on chip according to claim 1, wherein the verification circuitry is configured to perform the determination so that the access is blocked if at least one item of the transaction information stored in the command register belongs to the list of special information, or if at least one item of the transaction information stored in the command register does not belong to the list of special information.

5. The system on chip according to claim 1, wherein the list of special information is established on at least one of the following types of transaction information: a pre-established command for an action in the memory; a memory region address; or a memory region size.

6. The system on chip according to claim 1, wherein the verification circuitry is integrated directly internally into the memory controller.

7. The system on chip according to claim 1, wherein each element of the list of special information comprises a pre-established command for an action in the memory, the pre-established commands being coded on 8 bits.

8. A method for controlling a memory, the method comprising:
receiving, at a memory controller of a system on chip, transactions containing transaction information for a respective access to the memory;
storing, at the memory controller, the transaction information received in a command register, the access to the memory being controlled from the content of the command register; and
determining, at the memory controller, the access to the memory depending on a comparison between the transaction information stored in the command register and a list of special information comprising special transactions.

9. The method according to claim 8, further comprising receiving a security level of the system on chip, and wherein the determination of the access to the memory is performed depending on the security level of the system on chip.

10. The method according to claim 9, wherein the list of special information comprising special transactions is created respectively for each possible security level of the system on chip.

11. The method according to claim 8, wherein the determination is performed so that the access is blocked if at least one item of the transaction information stored in the command register belongs to the list of special information, or if at least one item of the transaction information stored in the command register does not belong to the list of special information.

12. The method according to claim 8, wherein the list of special information is established on at least one of the following types of transaction information: a pre-established command for an action in the memory; a memory region address; or a memory region size.

13. The method according to claim 8, wherein each element of the list of special information comprises a pre-established command for an action in the memory, the pre-established commands being coded on 8 bits.

14. A system on chip comprising:
a memory controller, the memory controller configured to: receive transactions containing transaction information for an access to the memory controller or an access to a memory from a central processing unit, and to control the access to the memory using the transaction information, the memory controller comprising verification circuitry configured to determine the access to the memory depending on a comparison between the transaction information and a list of special information comprising special transactions.

15. The system on chip according to claim 14, wherein the verification circuitry is configured to receive a security level of the system on chip and to perform the determination of the access to the memory depending on the security level of the system on chip.

16. The system on chip according to claim 15, wherein the list of special information comprising special transactions is created respectively for each possible security level of the system on chip.

17. The system on chip according to claim 14, wherein the verification circuitry is configured to perform the determination so that the access is blocked if at least one item of the transaction information belongs to the list of special information, or if at least one item of the transaction information does not belong to the list of special information.

18. The system on chip according to claim 14, wherein the list of special information is established on at least one of the following types of transaction information: a pre-established command for an action in the memory; a memory region address; or a memory region size.

19. The system on chip according to claim 14, wherein the verification circuitry is integrated directly internally into the memory controller.

20. The system on chip according to claim 14, wherein each element of the list of special information comprises a pre-established command for an action in the memory, the pre-established commands being coded on 8 bits.
